(19) United States
(12) Patent Application Publication
(10) Pub. No.: US 2014/0207528 A1
(43) Pub. Date: Jul. 24, 2014

(54) SYSTEM, METHOD AND COMPUTER PROGRAM FOR IDENTIFYING VALUE AGGREGATION POINTS FROM A SET OF SERVICE VALUE MAPS

(71) Applicant: International Business Machines Corporation, Armonk, NY (US)

(72) Inventors: Heiko LUDWIG, San Francisco, CA (US); Rakesh Mohan, Corlandt Manor, NY (US); Ajay Mohindra, Yorktown Heights, NY (US); Mahmoud Naghshineh, Hopewell Junction, NY (US); Yuichi Nakamura, Kanagawa-ken (JP); Bikram Sengupta, Bangalore (IN)

(73) Assignee: International Business Machines Corporation, Armonk, NY (US)

(21) Appl. No.: 13/960,217

(22) Filed: Aug. 6, 2013

Related U.S. Application Data
(63) Continuation of application No. 13/747,689, filed on Jan. 23, 2013.

(51) Int. Cl. G06Q 10/06

(52) U.S. Cl. CPC G06Q 10/06375; G06Q 10/06393
USPC 705/7.37; 705/7.39

(57) ABSTRACT

A data processing system provides a set of service value maps (SVMs) each having a plurality of nodes and linkages between nodes, forms a network model based on the SVMs and analyses the network model to compute aggregate values for the nodes to enable an identification of a node that matches at least one criterion. Analyzing can include using a degree centrality process where a value for each node is defined as a number of outgoing edges from the node, or an eigenvalue centrality process where a value of a node is proportional to a value of those nodes that the node is connected to. Each SVM can be represented as a directed acyclic graph (DAG) where each edge between nodes is an edge in the DAG. The at least one criterion can include a highest valued node identifying a value aggregation point (VAP) of the set of SVMs.

### CLAIM OF PRIORITY FROM COPENDING PROVISIONAL PATENT APPLICATION

This patent application claims priority under 35 U.S.C. §119(e) from U.S. Provisional Patent Application No. 61/589,962, filed on Jan. 24, 2012, the disclosure of which is incorporated by reference herein in its entirety.

### CROSS REFERENCE TO A RELATED US PATENT APPLICATION

This patent application is related to copending and commonly owned U.S. patent application Ser. No. 13/723,280, filed on Dec. 21, 2012, entitled “System, Method And Computer Program For Capturing Relationships Between Business Outcomes, Persons And Technical Assets” by Heiko Ludwig, Rakesh Mohan, Ajay Mohindra, Yuhichi Nakamura, Mahmoud Naghshineh and Bikram Sengupta, the disclosure of which is incorporated by reference herein in its entirety.

### CROSS-REFERENCE TO ANOTHER RELATED PATENT APPLICATION

This patent application is a continuation patent application of copending U.S. patent application Ser. No. 13/747,689, filed Jan. 23, 2013, the disclosure of which is incorporated by reference herein in its entirety.

### TECHNICAL FIELD

The exemplary embodiments of this invention relate generally to methods, data processing systems and computer software and computer-readable mediums that contain computer software configured and adapted for at least one or more of determining causality links, determining information technology (IT) outcomes, determining business (enterprise) outcomes and, even more generally, to enterprise architectures and to techniques that operate with a component business model (CBM) and with at least one a service value map (SVM).

### BACKGROUND

General reference may be had to the following commonly assigned US Patent Applications: US 2010/0250300 A1, Method for Transforming an Enterprise Based on Linkages Among Business Components, Business Processes and Services, Antoun et al.; US 2010/0107135 A1, System and Method for Transforming a Component Business Model, Arsanjani et al.; US 2009/0018879 A1, Method and System Supporting Business Solution Validation in a Component Business Model, Flaxer et al.; and US 2008/0215398 A1, System And Method for Using a Component Business Model to Manage an Enterprise, Cohn et al.

The above referenced US 2010/0107135 A1 defines a CBM as a model of a business including a plurality of non-overlapping business components representing a target state of the business, with each component being a group of cohesive business activities. Preferably the CBM includes the following elements: (i) Business Components element; (ii) Business Competency element; and/or (iii) Business Service element and/or (iv) Business Activity element. The CBM can include a heat map defined as a set of data identifying at least one critical business component(s) in a CBM, without regard to: (i) whether the heat map assigns a priority value to all components; (ii) the number of possible priority values used in the heat map; and/or (iii) the criteria and/or manner by which critical components are selected.

Enterprises are primary concerned with achieving key (i.e., significant and/or important) business outcomes. Business outcomes may be defined as outcomes that focus on factors that impact the business performance such as revenue, cost, and profit. Some examples of business outcomes are metrics such as increasing sales, reducing the cost of customer acquisition, reducing customer chum, etc. In contrast, service providers are concerned with delivering and measuring IT outcomes delivered through some set of IT services. IT outcomes may be defined as outcomes that focus only on the performance of information technology related metrics such as cost, utilization and management of IT resources. Some examples of IT outcomes are mean-time-between-failures of servers at a data center, average server utilization, average storage utilization, service level agreements, and/or the number of server per system administrator.

In general the Component Business Model (CBM) has focused on representing business components, competencies and a decision framework while an Enterprise Architecture (EA) has focused on a process of translating business vision and strategy into effective enterprise change by creating, communicating and improving the key requirements, principles and models that describe the enterprise's future state and enable its evolution.

### SUMMARY

In a first aspect thereof the exemplary embodiments of this invention provide a computer-implemented method that includes providing a set of service value maps each comprising a plurality of nodes and linkages between nodes; forming a network model based on the set of service value maps; and analyzing the network model to compute aggregate values for the nodes to enable an identification of a node or nodes that match at least one criterion.

In a still further aspect thereof the embodiments of this invention provide a computer-readable data storage medium that stores program code representing a computer program that is executable by at least one data processor. Execution of the computer program comprises operations of providing a set of service value maps each comprising a plurality of nodes and linkages between nodes; forming a network model based on the set of service value maps; and analyzing the network model to compute aggregate values for the nodes to enable an identification of a node or nodes that match at least one criterion.

In yet another aspect thereof the embodiments of this invention provide a data processing system that comprises at least one data processor connected with at least one computer-readable medium that stores program code that is executable by the at least one data processor. The at least one computer-readable medium also stores a set of service value maps each comprising a multi-layered hierarchical arrangement of nodes having causal links between at least some nodes of a particular layer and at least some nodes of next higher layer, where a service value map comprises at a topmost layer at least one desired outcome for an entity associated with the service value map, at a next lower layer capabilities that support the at least one desired outcome and, for each identified capability, processes and activities that comprise at a next lower layer organization solutions comprising identified solution assets and components that support the capabilities and that contribute towards the at least one desired outcome. The identified solution assets and components are mapped to specific infrastructure nodes in a lower-most layer of the hierarchical arrangement of nodes of the service value map. The at least one data processor executes program code configured to perform operations on the set of service value maps of forming a network model based on the set of service value maps and analyzing the network model to compute aggregate values for the nodes to enable an identification of a node or nodes that match at least one criterion.

In yet a still further aspect thereof the embodiments of this invention provide a data processing system that comprises at least one data processor connected with at least one computer-readable medium that stores program code that is executable by the at least one data processor to perform operations that comprise providing a set of service value maps each comprising a plurality of nodes and linkages between nodes; forming a network model based on the set of service value maps; and analyzing the network model to compute aggregate values for the nodes to enable an identification of a node or nodes that match at least one criterion.

### BRIEF DESCRIPTION OF THE SEVERAL VIEWS OF THE DRAWINGS

FIG. 1 shows a non-limiting example of a hierarchical Service Value Map (SVM) in accordance with an aspect of the invention disclosed in the above-referenced U.S. patent application Ser. No. 13/723,280.

FIG. 2 shows an example of a SVM schema composed of an Enterprise Architecture (EA) hierarchy arranged, by example, as Infrastructure. Solution, Capability and Outcome layers, and also shows a key performance indicator (KPI) tree having KPI elements that are linked to at least some elements of the SVM and to one another.

FIG. 3 shows an exemplary block diagram of a system that is suitable for implementing the embodiments of the invention disclosed in the above-referenced U.S. patent application Ser. No. 13/723,280.

FIG. 4 is a logic flow diagram that depicts method steps in accordance with embodiments of the invention described in U.S. patent application Ser. No. 13/723,280, as well as a result of execution of computer software stored in a memory shown in FIG. 3.

FIG. 5 is a logic flow diagram that is descriptive of an embodiment of a process for creating a Service Value Map such as the non-limiting examples of the Service Value Maps shown in FIGS. 1 and 2.

FIG. 6 shows a non-limiting example of a SVM that is useful in explaining aspects of this invention.

FIG. 7 is a logic flow diagram of a method having steps used to form and analyze a network model based on SVMs in accordance with embodiments of this invention.

FIG. 8 depicts an example of the labeling of the nodes in the SVM of FIG. 6 using a Breadth-First order.

FIG. 9 depicts a non-limiting example of an Adjacency Matrix of an SVM, where a matrix is constructed for the SVM after the nodes are labeled, and a value of “1” is entered in a cell if there is an edge between two nodes in the SVM.

FIG. 10 depicts a non-limiting example of a Degree matrix of an SVM.

FIG. 11 is a logic flow diagram that depicts method steps in accordance with embodiments of this invention.

### DETAILED DESCRIPTION

Service providers strive to maximize their return on investment (ROI) in key technologies to provide differentiation for their offerings. Service Value Maps provide a framework to link industry specific business outcomes to business capabilities, solutions and infrastructure. However, it may be typically the case that service providers follow an ad-hoc process to identify and invest in solution and infrastructure capabilities due to a lack of visibility into areas of high value to the service provider.

The examples of the embodiments of this invention provide a methodology to identify one or more value aggregation points (VAPs) in a set of service value maps (SVMs) based on specific attribute values that represent relationships among components and nodes of the SVMs. The set of SVMs can comprise one member (one SVM) or more than one member (two or more SVMs).

Various aspects of the embodiments of the invention include, but are not limited to:

(a) the use of SVMs that include causal linkages, having associated weight values, between components across multiple attributes such as contribution, cost, complexity, as described in the above-referenced U.S. patent application Ser. No. 13/723,280;
(b) an identification of the key business capabilities that support each business outcome, as described in the above-referenced U.S. patent application Ser. No. 13/723,280;
(c) a transformation of the values of the causal relationships of the SVM into a network model comprised of nodes;
(d) analysis of the network model to compute aggregate values for the nodes according to selected attribute(s); and
(e) an identification of one or more of the nodes that match selected criteria.

Before describing in detail the exemplary embodiments of this invention a description will be made of the various embodiments of the invention described in U.S. patent application Ser. No. 13/723,280. As will become apparent the embodiments of the present invention may utilize certain aspects of an SVM having weighted edges/linkages between nodes as described in U.S. patent application Ser. No. 13/723,280.

To be successful in a competitive marketplace it would be desirable for Service providers to be capable of relating proposed and/or provided IT assets to key business outcomes of an Enterprise (e.g., a client of the Service provider), and to express using some readily understood metric or metrics a degree of contribution that each IT asset makes towards achieving a desired business outcome of an Enterprise.

The examples of the embodiments of the invention described in the above-referenced U.S. patent application Ser. No. 13/723,280 provide a computer-implemented methodology and system to create and represent Service Value Maps (SVMs) that capture and represent relationships among various outcomes to underlying technology assets. In accordance with a method this is accomplished by building a library of known industry-specific business outcomes for various organizations of interest; identifying key business capabilities that support each business outcome; for each identified business capability, identifying key processes and activities that support the business outcomes; and for each key process and activity, identifying solution assets and components that contribute towards the business outcomes. The identified solution assets and components are then mapped to specific infrastructure elements. Linkages between the identified solution assets and components are assigned weights to indicate how much each asset and component contributes as a percentage to the business outcomes.

The library of SVMs that has been created for different industries and different clients within an industry enables analysis and reuse of SVMs.

Non-limiting examples of an ‘organization’ that can benefit from the use of the embodiments of the invention described in the above-referenced U.S. patent application Ser. No. 13/723,280, as well as the embodiments of the present invention include, but are not limited to, wired and wireless telecommunications businesses, for-profit and not-for-profit healthcare businesses, charities, government agencies, banking institutions, financial/mortgage institutions, retailers of various consumer goods, manufacturers of various products including consumer goods and components used to fabricate consumer goods, and suppliers of goods and/or services of a military/defense nature.

As used herein an ‘entity’ can be any organization (for-profit or not-for-profit) such as a business, a charity or a government agency.

As used herein a reference to a ‘Business Outcome’ can be broadly construed to mean any ‘desired outcome’ of an entity or organization, e.g., increasing sales, reducing cost, increasing an amount of charitable contributions, expanding a customer/subscriber base, reducing customer chum (increasing customer retention), loss mitigation, fraud detection, reducing time required to launch a new product, reduce out-of-stock incidents at retail outlets, etc. A desired Business Outcome may be considered as a business ‘Goal’. A Business Outcome may be measured by Key Performance Indicators (KPIs), such as: reduce customer churn <20%, or reduce fraudulent claims to <5%, etc.

As employed herein the Component Business Model (CBM) can be considered to represent business components, competencies and decision framework(s). An Enterprise Architecture (EA) can be considered to represent a mechanism and process for translating business goals and strategies into effective enterprise change by creating, communicating and improving key requirements, principles and models that describe a future state of the Enterprise and enable the evolution of the Enterprise from a current state to the desired future state. The embodiments of this invention focus at least in part on the contribution level of a capability to the overall desired business outcome. The embodiments of this invention extend a conventional CBM concept by adding the values (weights) to the relationships between components and capabilities, and supporting assets.

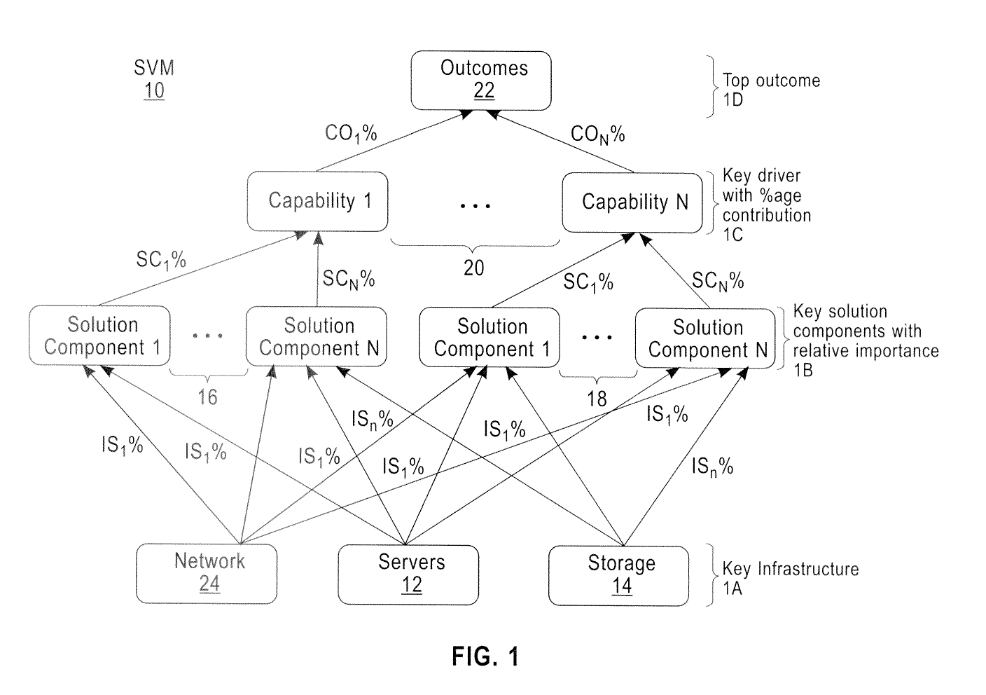

FIG. 1 shows a non-limiting example of a hierarchical Service Value Map (SVM) 10 in accordance with the invention described in the above-referenced U.S. patent application Ser. No. 13/723,280. The SVM 10 includes a number of elements. also referred to herein without a loss of generality as “nodes”. A first level 1A (Level₁) includes Key Infrastructure elements such as servers 12, network 24 and storage 14. The first level 1A can also include, as non-limiting examples, software such as an operating system or operating systems, middleware, and database management systems. The first level 1A can also include, depending on the nature of the business, a data center, a call center, a contact center, and/or a help-desk. The Infrastructure layer 1A can generally include any hardware/software/network(s) and associated support hardware/software/network(s) and personnel needed by an associated entity to function and interact with customers/clients/contributors/subscribers, etc.

A second level 1B (Level₂) contains key Solution component elements with their relative importance. In this example there are two Solution component elements 16 and 18 each comprising some number (e.g., N) of sub-components. The Solution component elements 16 and 18 could also be referred to as Business Services such as customer relationship management (CRM), billing, and order management.

A third level 1C (Level₃) contains key driver elements 20 including Capability 1 through Capability N, such as sales, order handling, customer quality of service, billing and collections management, billing inquiries, etc., each of which makes some percentage contribution (CO %) in a linkage (L) to a final (top) Outcome(s) element 22 at a fourth level 1D (Level₄) of the SVM 10. Capabilities or Business capabilities may be defined as what a business does, such as the services it provides to customers, or the operational functions it performs for employees. Note that each element of the SVM 10 could be further decomposed into more detailed constituent elements.

In general, business outcomes 22 are enabled by the business capabilities 20 (e.g., retention, customer lifecycle management, etc.), which in turn are enabled by the business services and solutions 16, 18, which in turn are enabled by the key infrastructure layer 1A that ideally supports flexible, reliable and secure infrastructure services to all of the overlying layers of the entity.

An aspect of the invention described in the above-referenced U.S. patent application Ser. No. 13/723,280 is the linkage (L) or linkages between the elements shown in FIG. 1. Each linkage (causal link), which can also be referred to without a loss of generality as an ‘edge’, is assigned a weight (expressed in a non-limiting example as a percentage %) to indicate how much the element from which the linkage originates contributes to an element or elements at a next higher level of the hierarchy. For example, in the SVM 10 the Servers infrastructure element 12 and the Network infrastructure element 24 each has an Infrastructure (IS) linkage to each of the overlying Solution component and sub-component elements 16 and 18, while the Storage infrastructure element 14 has IS linkages to some but not all of the overlying Solution component and sub-component elements 16 and 18. In like manner each of the Solution component and sub-component elements 16 and 18 has a linkage SC to the overlying Capability elements 20 that in turn have the above-mentioned CO linkages to the final (top) Outcome(s) 22. The weight assigned to each linkage can represent one or more attributes such as, for example, cost, contribution, price and/or a condition or conditions imposed by a service level agreement or agreements. The linkages and their associated weights can be considered as quantitatively indicating a contribution of a given element to an element higher in the hierarchy and, eventually, to the desired business outcome 22. The computation of a percentage weight for each link is a function of the attributes associated with the component in the SVM from which the link originates.

The Service Value Map 10 beneficially provides complete “line of sight” visibility from business outcomes to key technology and solution assets. The Service Value Map 10 also provides a framework for service providers to understand the technology and solution choices to deliver business based on the weights assigned to each edge of the SVM 10. The Service Value Map 10 further enables a client to understand how technology contributes to achieving business outcomes.

The SVM 10 may be considered to represent an industry-specific teardown of business outcomes at all levels of the hierarchical stack, with causal links between the elements of the SVM. The SVM 10 provides insight into key enablers for value and can identify value aggregation points through analysis. The causality links between elements across the layers of the SVM 10 can indicate by the strength of relationships between elements first order key drivers and can enable identification of high value assets. The various elements in the SVM 10 specify key attributes and metrics and characterize key high value assets and service specifications. The SVM 10 provides a structure to run analytics on to identify key nodes in a graph that are key enablers of an outcome. These key enablers can be enhanced as high value assets that are high percentage contributors to the outcome(s).

It can be noted that some business capabilities can be identified that are common across some or all industries (e.g., customer churn management). The value aggregation points and high value assets for these business capabilities can then be identified in specific industries (e.g., airline, healthcare, telecommunications, retail, etc.) with industry-specific analytics. It may be the case that some value aggregation points and high value assets for the common business capabilities can be used across industries without any industry-specific customization.

Next an optimization can be performed across the layers 1A-1D of the SVM 10 to tune the solutions and IT services together to deliver the maximum benefit to the client.

The embodiments of the invention described in the above-referenced U.S. patent application Ser. No. 13/723,280 provide a method and structure to represent business outcomes, where an outcome is linked to a set of supporting business capabilities; where each business capability is linked to a set of enabling solutions; where each solution is linked to a set of required infrastructure elements; and where each linkage between elements in a hierarchical arrangement of elements is assigned a weight that represents one or a plurality of attributes such as cost, contribution, price and service level agreements (SLAs).

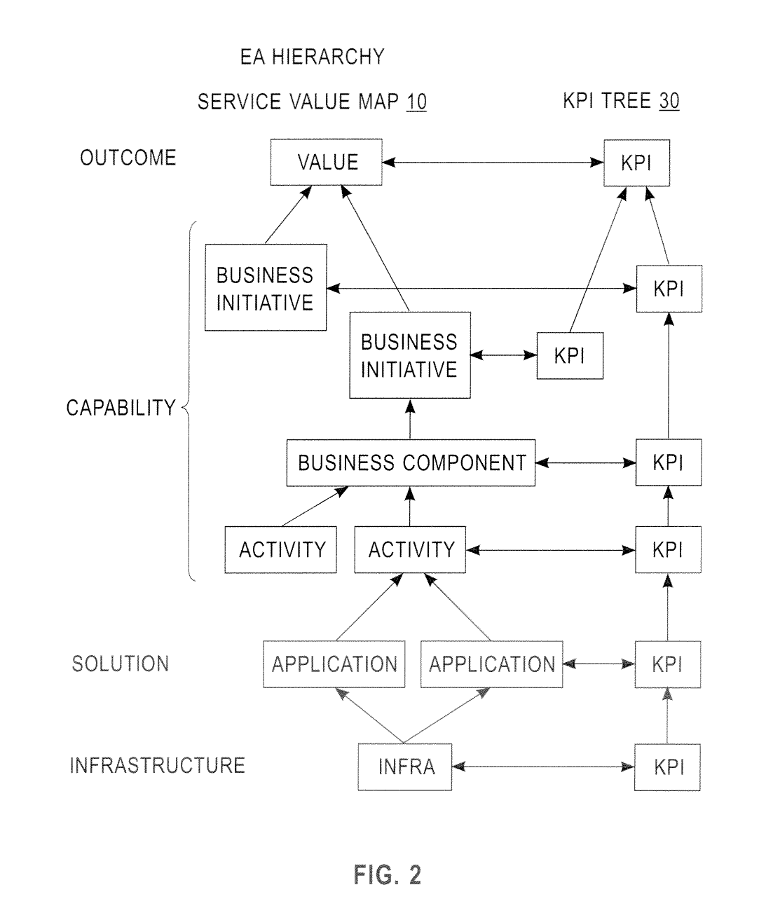

FIG. 2 shows an example of a Service Value Map schema composed of an Enterprise Architecture (EA) hierarchy arranged by example as Infrastructure 1A. Solution 1B. Capability 1C and Outcome 1D. In this example the Capability layer 1C includes a sub-hierarchy composed of elements (nodes): Activity. Business Component, and Business Initiative. The EA hierarchy in accordance with an aspect of this invention defines the causal relationships (the weighted linkages shown in FIG. 1) between Business and IT elements so as to explicitly represent how the IT elements contribute to the Business Outcome(s). In the SVM schema there is also a KPI tree 30 having KPI elements that are linked to at least some elements (nodes) of the SVM 10 and to one another. A KPI is calculated using child nodes. The EA hierarchy (SVM 10) is mapped onto the KPIs by a one-to-one mapping or a many-to-many mapping as appropriate. For example, a KPI S_{F} that measures the direct cost of frauds due to churns and operation cost is a function of three other KPIs: (1) % of churners due to fraudulent cases out of total number of churns P_{CPF}, (2) cost of helpdesk and inquiry per complaint C_{C}, and (3) average cost of bill adjustment per fraudulent case C_{B}. We can express S_{F} as

S_{F}=(P_{CF}/100)*C_{R}/100)*T_{P}*ARPU+(C_{C}+C_{B})*N_{F}

### Where

C_{R}=Total churn rate
T_{P}=Total number of subscribers
N_{F}=Number of frauds reported
ARPU=Average Revenue Per User

A service value map also represents a mathematical model that can be used to perform a what-if analysis. For example, when cost estimation can be used to extend the SVM 10, e.g., by defining a cost/KPI variation (best/worst/most likely) to each task, e.g., if x dollars are spent for task y for the best case, then KPI z can be improved by 5% as compared to the most likely case). Then a best solution can be selected considering the cost and outcome for each case.

Traditional tools in the prior-art implement only a subset of the capability offered by Service Value Maps in accordance with the embodiments of this invention. For example. Component Business Modeling (CBM) (http://www-935.ibm.com/services/us/en/business-services/ibm-component-business-modeling-services-sm.html) identifies the basic building blocks of an enterprise as competencies that can be used to create a model of the essential business processes in the industry, using it to identify differentiating and non-differentiating components and isolate those presenting immediate opportunities for growth, innovation or improvement. A CBM does not extend its scope to the supporting solution and infrastructure components, and causality links between components. The Rational System Architect (http://www-01.ibm.com/software/awdtools/systemarchitect/) provides a platform for visualizing, analyzing and communicating an organization's enterprise architecture and business process analysis. Its scope does not extend to mapping the Enterprise architecture to supporting solution and infrastructure components, and causality links between components. In addition to the foregoing tools, the Rational Software Architect (http://www-01.ibm.com/software/awdtools/swarchitect/) provides integrated design and development support for model-driven development with the UML. Its scope is limited to development of solution components independent of business outcomes, capabilities, and infrastructure components. It also does not support any causality links between components.

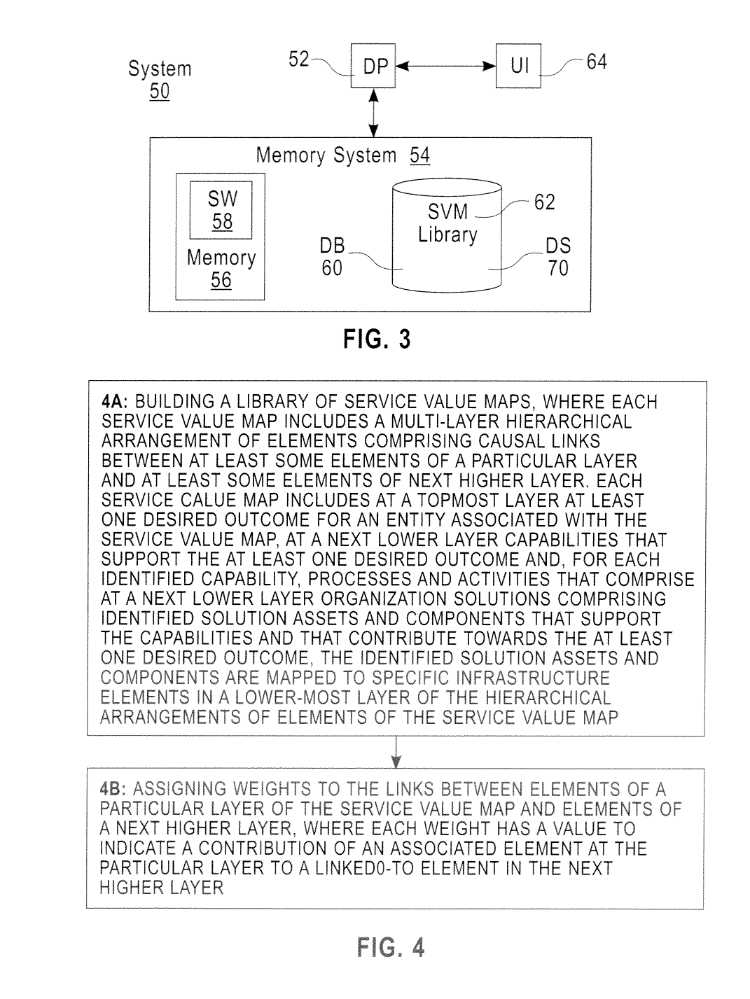

FIG. 3 shows an exemplary block diagram of a system 50 that is suitable for implementing the embodiments of the invention described in the above-referenced U.S. patent application Ser. No. 13/723,280, as well as the exemplary embodiments of this invention. The system 50 includes at least one data processor 52 connected with at least one computer-readable medium such as one embodied as a memory system 54. The memory system 54 can include a memory 56 storing computer program code implementing computer software (SW) 58 that, when executed by the data processor 52, can result in the performance of methods in accordance with the above-referenced U.S. patent application Ser. No. 13/723,280 as well as the exemplary embodiments of this invention. The memory system 54 may also include a database (DB) 60 can store a library 62 of the SVMs 10. As was noted above the library 62 can be populated with SVMs 10 configured to represent one or more industries/organizations of interest. A user interface 64, such as a graphical user interface (GUI), is provided enabling a user of the system 50 to interact with the software 58 and the library 62 of SVMs 10 in order to open a particular SVM of interest and modify at least one or more of the linkage values between SVM elements in order to tune and optimize the SVM for a particular client in a particular industry/organization. Changes to a particular SVM 10 can be saved in the database 60 for possible reuse.

The system 50 could implemented at single geographical location, such as one associated with a certain IT service provider, or it could be implemented and distributed over multiple locations and the components networked together by any suitable wired and/or wireless connections. In some embodiments the system 50 could be instantiated in whole or in part in a cloud computing environment.

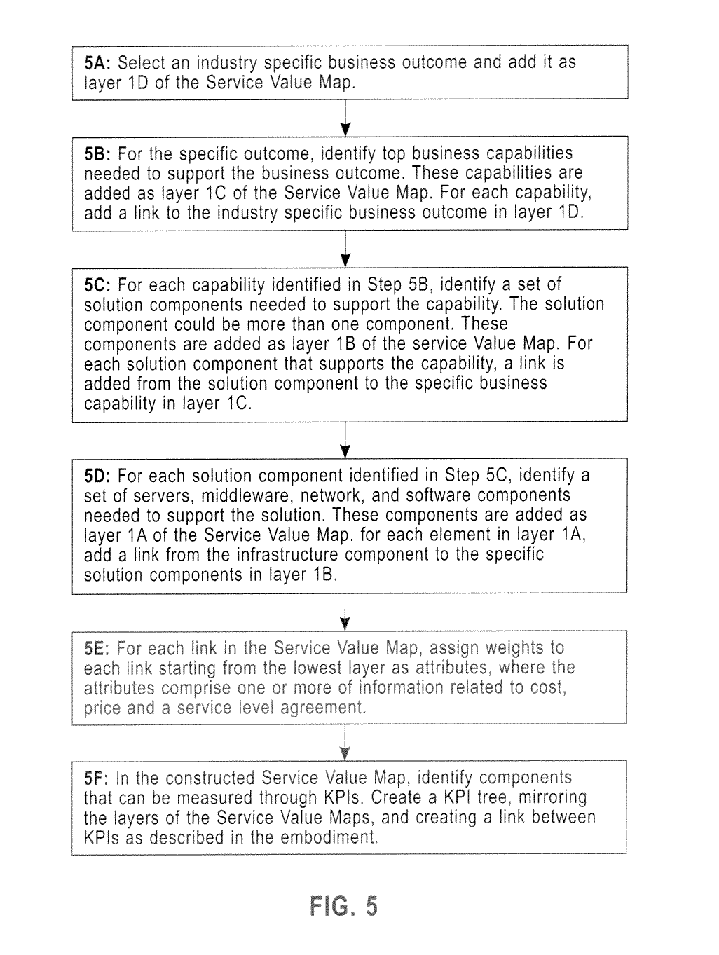

It should be appreciated that a given SVM 10 when stored in the computer-readable medium, such as the database 60, can be considered to represent a data structure (DS) 70 that is readable and possibly modifiable by the data processor 52. The creation of an SVM 10 is described in relation to FIG. 5.

FIG. 4 is a logic flow diagram that depicts method steps in accordance with embodiments of the invention described in the above-referenced U.S. patent application Ser. No. 13/723,280, as well as a result of execution of the software 58 stored in the memory 56 of FIG. 3. The computer-implemented method includes at Block 4A a step of building a library of service value maps, where each service value map includes a multi-layered hierarchical arrangement of elements comprising causal links between at least some elements of a particular layer and at least some elements of next higher layer. Each service value map includes at a topmost layer at least one desired outcome for an entity associated with the service value map, at a next lower layer capabilities that support the at least one desired outcome and, for each identified capability, processes and activities that comprise at a next lower layer organization solutions that support the capabilities and, for each solution, assets and components that contribute towards the at least one desired outcome. The identified solution assets and components are mapped to specific infrastructure elements in a lower-most layer of the hierarchical arrangement of elements of the service value map. The method further includes at Block 4B a step of assigning weights to the links between elements of a particular layer of the service value map and elements of a next higher layer, where each weight has a value to indicate a contribution of an associated element at the particular layer to a linked-to element in the next higher layer.

In the method depicted in FIG. 4 a weight has a value that indicates a percentage contribution of an associated element at the particular layer to a linked-to element in the next higher layer and is a function of at least one attribute of the associated element, where an attribute comprises information related to at least one or more of cost, price and a service level agreement.

In the method depicted in FIG. 4 there can be a further step of varying a value of a weight of least one link to determine an optimal service value map for a particular entity.

In the method depicted in FIG. 4 there can be a further step of varying a value of a weight of least one link to determine an optimal configuration of elements that comprise the infrastructure layer for a particular entity.

In the method depicted in FIG. 4, where a service value map comprises a part of a schema comprising a hierarchical arrangement of key performance indicator elements having links to at least some of the elements of the service value map.

In the method depicted in FIG. 4 there can be a further step of opening the library of service value maps and selecting a most appropriate service value map as an initial service value map for use with a particular entity.

The method of FIG. 4 is performed as a result of execution of computer program code stored in a computer-readable medium.

FIG. 5 is a logic diagram of a process for creating a Service Value Map further in accordance with the embodiments of the invention described in the above-referenced U.S. patent application Ser. No. 13/723,280. In the step shown in Block 5A, the first step is to select an industry specific business outcome and add it as layer 1D of the Service Value Map. Next in Block 5B, for the specific outcome, identify top business capabilities needed to support the business outcome. These capabilities are added as layer 1C of the Service Value Map. For each capability, add a link to the industry specific business outcome in layer 1D. In Block 5C. for each capability identified in Step 5B, identify a set of solution components needed to support the capability. The solution component could be more than one component. These components are added as layer 1B of the Service Value Map. For each solution component that supports the capability, a link is added from the solution component to the specific business capability in layer 1C. In Block 5D, for each solution component identified in Block 5C, identify a set of infrastructure components such as servers, middleware, network, and software components needed to support the solution. These components are added as layer 1A of the Service Value Map. For each element in layer 1A, add a link from the infrastructure component to the specific solution components in layer 1B.

In Block 5E, for each link in the Service Value Map, assign weights to each link starting from the lowest layer as attributes, where the attributes comprise one or more of information related to cost, price and a service level agreement.

In Block 5F, in the constructed Service Value Map, identify components that can be measured through KPIs. This can entail creating a KPI tree that mirrors the layers of the Service Value Maps, and creating links between KPIs as described earlier.

Having thus described the embodiments of the invention disclosed in the above-referenced U.S. patent application Ser. No. 13/723,280 there will now be described in greater detail various embodiments of this invention. The embodiments of this invention further enhance the operation of the system 50 so as to identify Value Aggregation Points (VAPs) in a set of Service Value Maps 10 based on specific attribute values that represent the relationships among components of the Service Value Maps 10. As was noted above the set of Service Value Maps can include one member or more than one member.

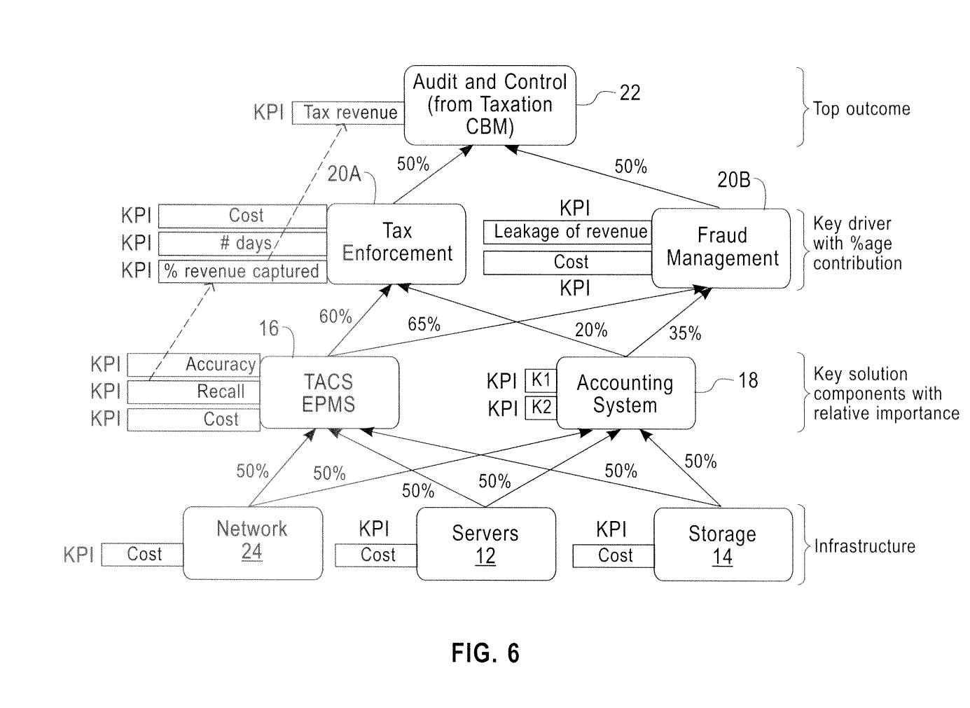

FIG. 6 shows a non-limiting example of a SVM 10 where the various layers can be arranged and designated as in FIG. 1. In this non-limiting example the SVM 10 can be considered to include a high value asset tax and compliance solution (TACS) that contains an entity profiling management system (EPMS). The TACS and EPMS may be considered as being of a “high value” to, for example, a vendor of the TACS system/software. Along the lines of the above description of FIG. 1 the SVM 10 of FIG. 6 includes the first level 1A (Level₁) that includes Key Infrastructure elements such as the above mentioned servers 12, network 24, and storage 14, and also includes the second level 1B (Level₂) that contains key Solution component elements with their relative importance. In this example there are two Solution component elements 16 and 18 one of which is the TACS and the other of which is an accounting system. A third level 1C (Level₃) contains key driver elements 20 including a tax enforcement process entity 20A and a fraud management activity element 20B. In this example tax enforcement process entity 20A has an output linked to, and which makes a contribution (e.g., 50%) to, the final (top) Outcome element 22 (Audit and Control) at a fourth level 1D (Level₄) of the SVM 10. As was noted previously each element of the SVM 10 could be further decomposed into more detailed constituent elements.

Various KPIs are shown associated with these various SVM nodes. The KPIs can be considered to form a KPI tree 30 as was depicted in FIG. 2 and described above.

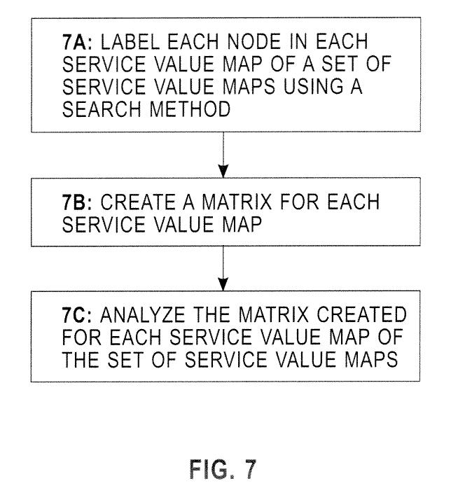

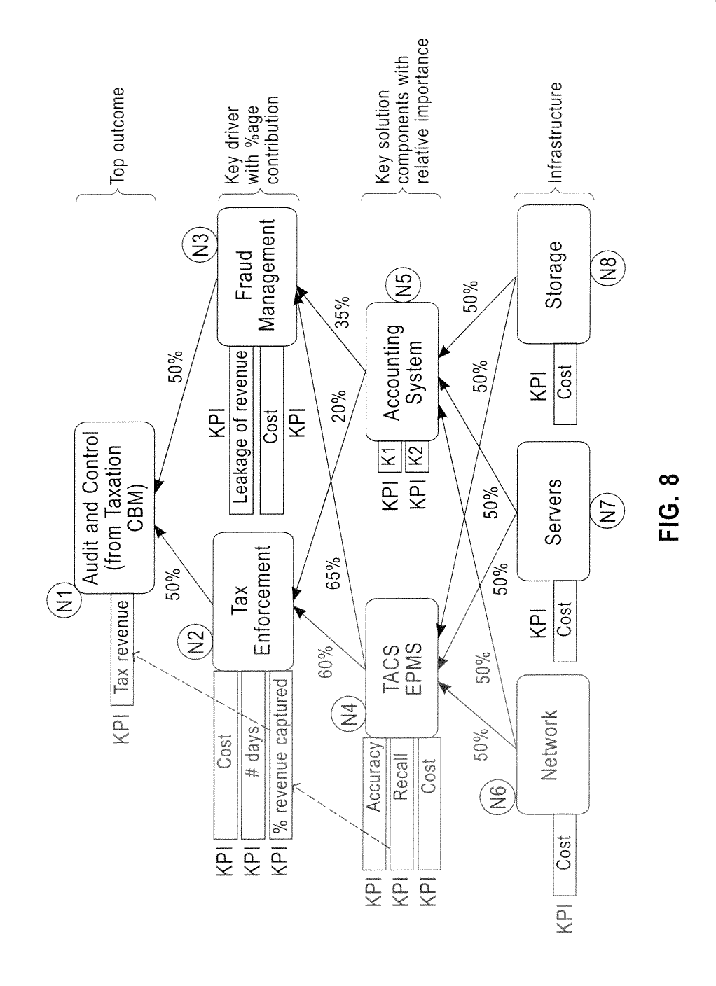

FIG. 7 shows steps used to form and analyze a network model based on SVMs 10. In Step 7A the method uniquely identifies (labels) each node in the Service Value Map during a search method. In some embodiments of this invention, to ensure consistency, the search method can be a breadth-first search method while in other embodiments the search method could be a depth-first search method. In the non-limiting example of the breadth-first search method one can start with the root Outcomes 22 node and label it N as shown in FIG. 8. Then continuing with the exemplary bread-first node labeling scheme shown in FIG. 8 the search method labels the nodes in third level 1C (Level₃) as N2 and N3. Next, nodes in second level 1B (Level₂) are labeled as N4 and N5. Lastly, nodes on the first level 1A (Level₁) are labeled as N6, N7 and N8.

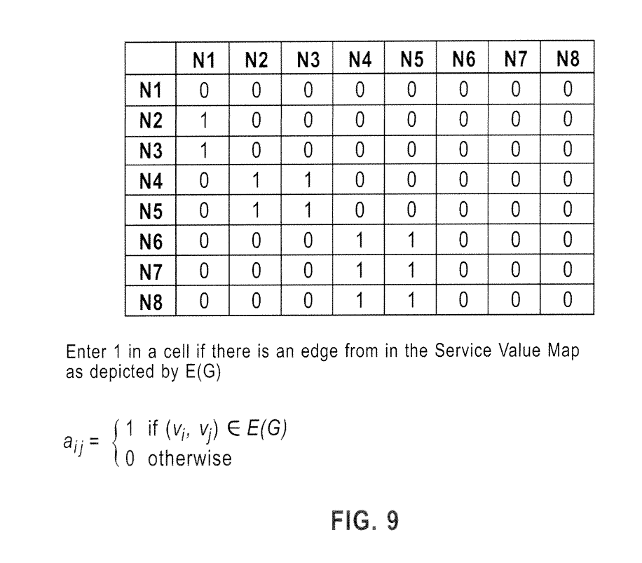

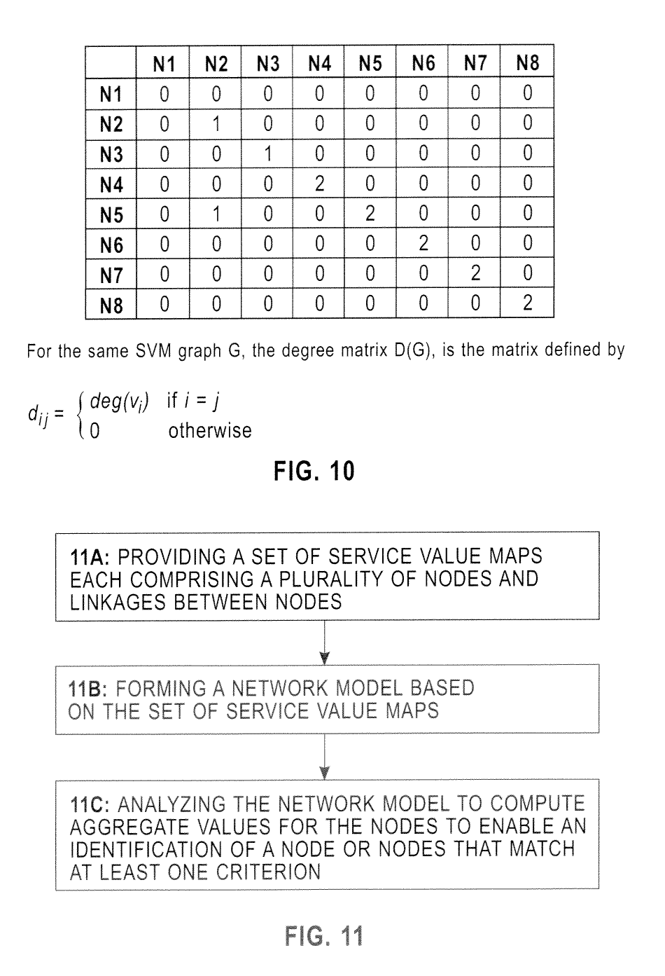

This labeling can be used to construct an Adjacency matrix for the SVM 10 of a type shown as an example in FIG. 9 or, alternatively, it can be used to construct a Degree matrix of the SVM 10 of a type shown as an example in FIG. 10. In general the type of matrix that is constructed, e.g. Adjacency or Degree, depends on a type of processing (analysis) to be performed in Step 7C, where if the analysis uses a Degree Centrality technique then the Degree matrix of FIG. 10 is constructed otherwise if an Eigenvalue Centrality analysis technique is used then the Adjacency matrix of FIG. 9 is constructed.

It is pointed out that the node labeling should be consistent when applied over two or more SVMs 10. For example, if the TACS node 16 of FIG. 6 appears in two or more SVMs 10 of the set of SVMs then it is consistently labeled as, e.g., N4 (node 4 as shown in FIG. 8) in each of the SVMs 10 in which it appears. In this case then the TACS node N4 can be considered as a common node shared by two or more SVMs 10, and the number of linkages associated with the common TACS node N4 would be the sum of all linkages in each of the SVMs of which it is a constituent (common) node.

Step 7B shown in FIG. 7 creates a matrix for each SVM, either the Adjacency matrix of FIG. 9 or the Degree matrix of FIG. 10 depending on the analysis to be performed in Step 7C.

In Step 7C of FIG. 7 the method analyzes the created matrix. The analysis can entail the use of, for example, the Degree Centrality approach or the Eigenvalue Centrality approach as explained in greater detail below.

Note that the Service Value Map 10 can be viewed and represented as a Directed Acyclic Graph (DAG), where each item (node) in the Service Value Map is a node in the DAG, and where each edge between components (nodes) is an edge in the DAG. One can consider as an example a case where a particular SVM 10 corresponds to only one business outcome. For such an SVM 10, such as the one depicted in FIG. 6, the DAG is labeled as G, with n vertices, V={v₁, . . . , vₙ}.

As shown in FIG. 9 an Adjacency graph (adjacency matrix) of G is the n×n square matrix A(G)=(aᵢⱼ) defined by:

$${a}_{ij} = \{ \begin{matrix}1 & if ( {v}_{i} , {v}_{j} ) ∈ E ( G ) \\ 0 & otherwise\end{matrix} ,$$

where E(G) is the edge set for graph G.

Note that if the multi-valued weights are used for the linkages then in the foregoing expression the “1” would be replaced by w, i.e., the value of the weight of the edge between vᵢ and vⱼ. A value of “0” is used for other cells where is no edge between vᵢ and vⱼ. In a most basic case all existent edges can be equally weighted as “1” prior to analysis, i.e., w=1 throughout the SVM 10.

As is shown in FIG. 10 for the same SVM graph G the degree matrix D(G) is a matrix defined by:

$${d}_{ij} = \{ \begin{matrix}deg ( {v}_{i} ) & if i = j \\ 0 & otherwise\end{matrix} .$$

A given set of SVMs 10 can exhibit causal linkages between components (nodes) across multiple attributes such as contribution, cost and complexity and, as was described above, can be used to identify key business capabilities that support business outcomes.

In accordance with aspects of this invention the values of the causal relationships of the set of SVMs 10 are transformed into a network model such as one represented by a multi-celled logical structure. An analysis of the network model is then performed to compute aggregate values for the nodes according to the selected attribute enabling an identification to be made of a node or nodes that match selected criteria.

For example, a vendor can be provided with knowledge of which are key attributes that may transcend multiple SVMs in various businesses thereby enabling the vendor to make better decisions as to where to focus future development/maintenance expenses. Also by example a business having one or several applicable SVMs can be enabled to identify one or more important/key nodes common to two or more business models in order to enhance risk management.

Different types of analysis can be used to determine a value of each node in the Service Value Map 10 (Step 7C). Two non-limiting examples of such analysis are described below.

A first analysis uses the Degree Centrality concept, where the value for each node can be defined as the number of outgoing edges from the node. A “most valued” node, if this is a selected criterion, is the node with the maximum number of outgoing edges. Mathematically this can be expressed as:

V_{d}(p)=deg(p)=number of outgoing connections from node p.

where the most valuable node is identified by max V_{d}(p).

A second non-limiting analysis uses the Eigenvalue Centrality concept which states that the value of a node is proportional to the value of the nodes that it is connected to. In this example let G be a Service Value Map graph where vertices are nodes, where edges are embodied as some form of causality links between vertices (nodes), and let A be the Adjacency Matrix of G. If there are N nodes in the SVM graph labeled p₁, p₂, . . . then the measure of value of each node can be stated as:

$${I}_{e} ( {p}_{i} ) = \frac{1}{λ} {\sum }_{j = 1}^{N} {A}_{i , j} {I}_{e} ( {p}_{j} ) ,$$

where A_{i,j} is the Adjacency Matrix of SVM G.

In this example a most valuable node is identified by max Iₑ(pᵢ). Similarly, the least valuable node is identified by min Iₑ(pᵢ).

The exemplary embodiments of this invention thus provide a system and a method for identifying one or more Value Aggregation Points (VAPs) from a set of Service Value Maps 10.

The memory system 54 shown in FIG. 3 that includes the memory 56 storing computer program code that implements the SW 58 can, when executed by the data processor 52, result in the performance of methods in accordance with the embodiments of this invention. For example some component or components of the SW 58 can be used to analyze the set of SVMs 10 to determine a value of each node in the SVM 10 and may implement, as non-limiting examples of analysis methods, one or both of the Degree Centrality and Eigenvalue Centrality methods/algorithms that were described above.

FIG. 11 is a logic flow diagram that depicts method steps in accordance with embodiments this invention, as well as a result of execution of the software 58 stored in the memory 56 of FIG. 3. The computer-implemented method includes at Block 11A a step of providing a set of service value maps each comprising a plurality of nodes and linkages between nodes. At Block 11B there is a step of forming a network model based on the set of service value maps. At Block 11C there is a step of analyzing the network model to compute aggregate values for the nodes to enable an identification of a node or nodes that match at least one criterion.

In the method shown in FIG. 11, where forming the network model comprises forming a degree matrix based on the nodes of a service value map and where analyzing comprises analyzing the degree matrix using a degree centrality process where a value for each node is defined as a number of outgoing edges from the node.

In the method shown in FIG. 11, where forming the network model comprises forming an adjacency matrix based on the nodes of a service value map and where analyzing comprises analyzing the adjacency matrix using an eigenvalue centrality process where a value of a node is proportional to a value of those nodes that the node is connected to.

In the method shown in FIG. 11, where each service value map of the set of service value maps is represented as a directed acyclic graph (DAG) where each node in the service value map is a node in the DAG, and where each edge between nodes is an edge in the DAG.

In the method shown in FIG. 11, where the at least one criterion comprises a highest valued node and identifies a value aggregation point of the set of service values maps.

In the method shown in FIG. 11, where analyzing comprises an initial step of uniquely identifying each of the nodes of each service value map during one of a bread-first search or a depth-first search, where a node that is common to two or more service value maps is labeled with the same identifier in each service value map.

The use of the exemplary embodiments of this invention is clearly advantageous when compared to the use of the conventional Component Business Model (CBM) that simply focuses on representing business components, competencies and a decision framework, as well when compared to a conventional enterprise architecture that simply provides a process of translating business vision and strategy into enterprise change by creating, communicating and improving the key requirements, principles and models that describe the enterprise's future state. Conventional network models that simply attempt to analyze some relationships between nodes are also improved upon.

While described herein partially in the context of services provided by an IT service provider it should be appreciated that a given business/organization could utilize the teachings of this invention for their own purposes to achieve optimized Business Outcomes in the hierarchy that includes base level resident IT components/services of the business/organization.

That is, and as was noted above, while the embodiments of this invention can be readily utilized to provide a service by one business for another business, these embodiments could also be utilized totally “in-house” to optimize Business Outcomes of a particular Enterprise.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a ‘circuit’, a ‘module’ or a ‘system’. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a single local computer, partly on the local computer, as a stand-alone software package, partly on the local computer and partly on a remote computer or entirely on the remote computer or server. In the latter scenario, the remote computer may be connected to the local computer through any type of network, including a LAN or a WAN, or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As such, various modifications and adaptations may become apparent to those skilled in the relevant arts in view of the foregoing description, when read in conjunction with the accompanying drawings and the appended claims. As but some examples, the use of other similar or equivalent mathematical expressions may be used by those skilled in the art. However, all such and similar modifications of the teachings of this invention will still fall within the scope of this invention.

What is claimed is:

1. A data processing system comprising at least one data processor connected with at least one computer-readable medium that stores program code that is executable by the at least one data processor, comprising:
a memory that stores a set of service value maps each comprising a multi-layered hierarchical arrangement of nodes having causal links between at least some nodes of a particular layer and at least some nodes of next higher layer, where a service value map comprises at a topmost layer at least one desired outcome for an entity associated with the service value map, at a next lower layer capabilities that support the at least one desired outcome and, for each identified capability, processes and activities that comprise at a next lower layer organization solutions comprising identified solution assets and components that support the capabilities and that contribute towards the at least one desired outcome,
where the identified solution assets and components are mapped to specific infrastructure nodes in a lower-most layer of the hierarchical arrangement of nodes of the service value map; and where said at least one data processor executes program code configured to perform operations on the set of service value maps of forming a network model based on the set of service value maps and analyzing the network model to compute aggregate values for the nodes to enable an identification of a node or nodes that match at least one criterion.

2. The data processing system of claim 1, where the operation of forming the network model comprises forming a degree matrix based on the nodes of a service value map and where the operation of analyzing comprises analyzing the degree matrix using a degree centrality process where a value for each node is defined as a number of outgoing edges from the node.

3. The data processing system of claim 1, where the operation of forming the network model comprises forming an adjacency matrix based on the nodes of a service value map and where the operation of analyzing comprises analyzing the adjacency using an eigenvalue centrality process where a value of a node is proportional to a value of those nodes that the node is connected to.

4. The data processing system of claim 1, where each service value map of the set of service value maps is represented as a directed acyclic graph (DAG) where each node in the service value map is a node in the DAG, and where each edge between nodes is an edge in the DAG.

5. The data processing system of claim 1, where the at least one criterion comprises a highest valued node and identifies a value aggregation point of the set of service values maps.

6. The data processing system of claim 1, where the operation of analyzing comprises an initial operation of uniquely identifying each of the nodes of each service value map during one of a bread-first search or a depth-first search, where a node that is common to two or more service value maps is labeled with the same identifier in each service value map.

7. The data processing system of claim 1, embodied in a cloud computing environment.

8. A data processing system comprising at least one data processor connected with at least one computer-readable medium that stores program code that is executable by the at least one data processor to perform operations that comprise:
providing a set of service value maps each comprising a plurality of nodes and linkages between nodes;
forming a network model based on the set of service value maps; and
analyzing the network model to compute aggregate values for the nodes to enable an identification of a node or nodes that match at least one criterion.

9. The data processing system of claim 8, where the operations of forming the network model comprises forming a degree matrix based on the nodes of a service value map and where analyzing comprises analyzing the degree matrix using a degree centrality process where a value for each node is defined as a number of outgoing edges from the node.

10. The data processing system of claim 8, where the operation of forming the network model comprises forming an adjacency matrix based on the nodes of a service value map and where analyzing comprises analyzing the adjacency matrix using an eigenvalue centrality process where a value of a node is proportional to a value of those nodes that the node is connected to.

11. The data processing system of claim 8, where each service value map of the set of service value maps is represented as a directed acyclic graph (DAG) where each node in the service value map is a node in the DAG, and where each edge between nodes is an edge in the DAG.

12. The data processing system of claim 8, where the at least one criterion comprises a highest valued node and identifies a value aggregation point of the set of service values maps.

13. The data processing system of claim 8, where the operation of analyzing comprises an initial operation of uniquely identifying each of the nodes of each service value map during one of a bread-first search or a depth-first search, where a node that is common to two or more service value maps is labeled with the same identifier in each service value map.

14. The data processing system of claim 8, where each service value map comprises a multi-layered hierarchical arrangement of nodes comprising causal links between at least some nodes of a particular layer and at least some nodes of next higher layer, each service value map comprising at a topmost layer at least one desired outcome for an entity associated with the service value map, at a next lower layer capabilities that support the at least one desired outcome and, for each identified capability, processes and activities that comprise at a next lower layer organization solutions comprising identified solution assets and components that support the capabilities and that contribute towards the at least one desired outcome, where the identified solution assets and components are mapped to specific infrastructure nodes in a lower-most layer of the hierarchical arrangement of nodes of the service value map, and further comprises weights that are assigned to the links between nodes of a particular layer of the service value map and nodes of a next higher layer, each weight having a value to indicate a contribution of an associated node at the particular layer to a linked-to node in the next higher layer, where a weight value indicates a percentage contribution of an associated node at the particular layer to a linked-to node in the next higher layer and is a function of at least one attribute of the associated node.

15. The data processing system of claim 14, where an attribute comprises information related to at least one or more of cost, price and a service level agreement.

16. The data processing system of claim 8, where a service value map comprises a part of a schema comprising a hierarchical arrangement of key performance indicator elements having links to at least some of the nodes of the service value map.

17. The data processing system of claim 8, embodied in a cloud computing environment.
